(19) United States
(12) Patent Application Publication
(10) Pub. No.: US 2026/0299120 A1
(43) Pub. Date: Oct. 1, 2026

(54) Radar System for a Vehicle, and Vehicle

(71) Applicant: Bayerische Motoren Werke Aktiengesellschaft, Muenchen (DE)

(72) Inventor: Florian DIRNBERGER, Viechtach (DE)

(21) Appl. No.: 19/491,001

(22) PCT Filed: Sep. 9, 2024
(86) PCT No.: PCT/EP2024/075069

§ 371 Date: Dec. 8, 2025

(30) Foreign Application Priority Data
Sep. 13, 2023 (DE) 10 2023 124 679.8

(51) Int. Cl. G01S 13/931; G01S 7/02; G01S 13/58

(52) U.S. Cl. CPC G01S 13/931; G01S 7/027; G01S 13/58

(57) ABSTRACT

A radar system for a vehicle includes a main support for securing to the vehicle, at least one radar connected to the main support, at least one optical element connected to the main support and spaced apart from the radar, and at least one absorber element arranged between the radar and the optical element. The optical element has at least two fasteners configured to cover sections of the absorber element and to fix the absorber element to the main support.

### BACKGROUND AND SUMMARY

The present invention relates to a radar system for a vehicle. The invention further relates to a vehicle with at least one such radar system.

Radar systems are employed in automotive engineering in order to detect objects—such as, for instance, other vehicles and/or pedestrians—and to measure their distance from the vehicle and also their relative velocity. For this purpose, a radar of the radar system emits electromagnetic waves which are reflected from the objects to be detected, and received back by the radar, and evaluated in a control instrument. In order to reduce the scattering of misdirected electromagnetic waves, it is known to surround the radar with an absorber device—for instance, an absorber element in the form of an absorber foam—and in this way to avoid defective images.

For the purpose of fastening an absorber element in the form of an absorber foam, it is known to clip the absorber foam on a support component. However, clips have the disadvantage that the absorber foam may be damaged in the course of installation. In addition, a clip always carries the risk of unintentional unclipping. Separate fastening concepts—such as screws or rivets, for instance—give rise to additional costs.

An alternative possibility for fastening an absorber foam is apparent from DE 10 2020 133 970 A1. In this patent, a radar arrangement for a motor vehicle is disclosed that includes at least one printed circuit board having an antenna arrangement and a control unit, which operates the antenna arrangement for the purpose of transmitting and receiving radar beams, and a housing having a housing body and a housing aperture constituted by side walls of the housing body. The printed circuit board is held in the housing body with an absorber which partially covers the surface of the printed circuit board facing toward the housing aperture, leaving the antenna arrangement exposed, the absorber being resiliently preloaded against the printed circuit board with the aid of a positive closure between the absorber and the housing body.

The task underlying the present invention is to create a radar system and also a vehicle that, in comparison with the prior art, guarantee a simple and cost-effective fastening of an absorber element.

With a view to achieving the task, a radar system and a vehicle with the features of the claimed invention are proposed.

According to a first aspect of the invention, a radar system for a vehicle is proposed. The radar system has a base support for fastening to the vehicle, at least one radar which is connected to the base support, at least one optical element which is connected to the base support and which is spaced from the radar, and at least one absorber element which is arranged between the radar and the optical element, the optical element having at least two fasteners which have been designed to mask portions of the absorber element and to fix the absorber element to the base support.

The radar system is distinguished in that the optical element, which is used anyway for optical reasons, is employed in order to fix the absorber element to the base support, in order to avoid an unintentional detachment of the absorber element from the base support. For this purpose, the optical element masks, or overlaps, portions of the absorber element, so that the absorber element has been fixed to the base support in a sandwich form of construction. As a consequence of this, a radar system that prevents an unintentional detachment of the absorber element—for instance, an unintentional unclipping—is created in simple and cost-effective manner.

The base support may take the form of a holder, by way of which the radar system is fastened to a vehicle. The radar, the optical element and the absorber element are fastened to the base support itself. The base support may consist of a synthetic material, in particular a fiber-reinforced synthetic material.

The optical element may take the form of a diaphragm and/or a light-conductor. The optical element may surround the radar completely while maintaining a spacing, by enclosing the radar, or the optical element may surround the radar only partially—for instance, it may surround one, two or three sides of the radar.

In an advantageous configuration, the fasteners fix the portions of the absorber element to the base support by positive closure and/or by force closure. By virtue of this, the fasteners act as counter-bearings for the absorber element, in order to prevent an unintentional detachment thereof. In particular, the absorber element, in particular the portions, is/are pressed between the fasteners and the base support. By virtue of this, the absorber element is preloaded against the base support with the aid of a positive closure between the portions and the fasteners.

In an advantageous configuration, the fasteners mask edge portions of the absorber element. By virtue of this, a secure fastening of the absorber element is achieved.

In an advantageous configuration, the fasteners have been screwed to the base support. As a consequence of this, the absorber element, in particular the edge portions, is/are pressed between the fasteners and the base support. Each fastener may have at least one aperture, through which a screw element is capable of being passed and capable of being screwed into a threaded aperture of the base support.

In an advantageous configuration, the at least two fasteners are arranged on two opposing sides of the optical element. By virtue of this, a sufficiently secure fastening of the absorber element is achieved, in order to prevent the absorber element from becoming detached from the base support.

In an advantageous configuration, the fastening element takes the form of a tab which masks the portion of the absorber element. The tabs have advantageously been screwed to the base support. For this purpose, the tab may have at least one aperture, through which a screw element is capable of being passed and capable of being screwed into a threaded aperture of the base support.

In an advantageous configuration, the base support has at least one detent element which is interlocked with a recess introduced into the absorber element. The absorber element is consequently additionally interlocked with, or clipped to, the base support. The fasteners, in particular the tabs, ensure that the absorber element remains fastened to the base support in the event of an unintentional separation of the clip connection.

In an advantageous configuration, the optical element is a light-guiding element and/or a diaphragm.

In an advantageous configuration, the absorber element has been produced from an expanded polypropylene (EPP foam). An absorber element consisting of an expanded polypropylene is cost-effective in production, and shields reliably against multiple reflections.

According to a further aspect of the invention, a vehicle is proposed that has at least one radar system.

In the following, a vehicle, a radar system and also further features and advantages will be described in more detail with reference to an embodiment that is represented schematically in the figures.

### BRIEF DESCRIPTION OF THE DRAWINGS

FIG. 1 shows a vehicle with a radar system.

FIG. 2 shows an enlarged front view of the radar system.

FIG. 3 shows an enlarged perspective representation of the radar system with a section along line III-III in FIG. 2.

FIG. 4 shows an enlarged plan view of the section from FIG. 3.

### DETAILED DESCRIPTION OF THE DRAWINGS

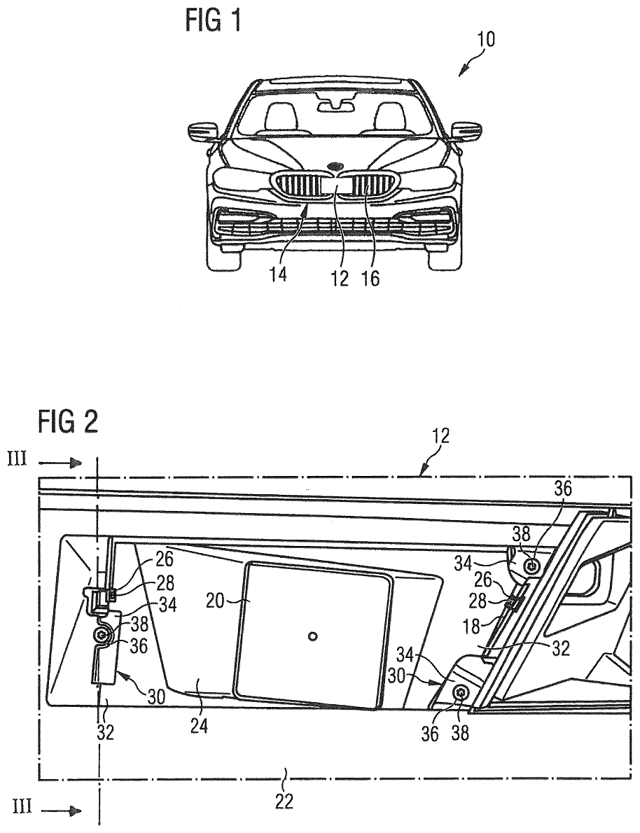

In FIG. 1 a vehicle 10 is shown which has a prime mover taking the form of an internal-combustion engine and/or an electric motor.

The vehicle 10 includes a radar system 12 which is arranged on a front end 14 of the vehicle in the region of a kidney grille 16.

As is evident in FIG. 2, the radar system 12 has a base support 18, a radar 20, an optical element 22 and an absorber element 24.

The base support 18 consists of a synthetic material, in particular a fiber-reinforced synthetic material, and serves to connect the radar system 12 to the vehicle. The radar 20, the optical element 22 and the absorber element 24 are fixed to the base support 18.

The radar 20 has been connected—for instance, screwed and/or clipped—to the base support 18, and serves for detecting an object—for instance, another vehicle or a person—in order to measure its distance from the vehicle 10, and also its relative velocity. For this purpose, the radar 20 emits electromagnetic waves, not represented, which are reflected from the object to be detected, and received by the radar 20, and evaluated by way of a control instrument which is not represented.

The optical element 22 surrounds the radar 20 and, in addition, is spaced from the radar 20, as is evident in FIG. 2. In the present case, the optical element 22 is a diaphragm or a light-conductor, and is connected to the base support 18, as will be elucidated in still more detail in the following.

The absorber element 24 serves to absorb radar beams. By virtue of this, the absorber element 24 shields the radar 20 in the direction of the vehicle 10—that is to say, toward the rear—against multiple reflections, so that defective images are avoided. For this purpose, the absorber element 24 is arranged between the radar 20 and the optical element 22, and consists of an expanded polypropylene (EPP foam).

For the purpose of fastening the absorber element 24 to the base support 18, the absorber element 24 has been clipped to the base support 18. For this purpose, the base support 18 has protruding clips 26 which are interlocked with recesses 28 which have been introduced into the absorber element 24.

In order to prevent the absorber element 24 from becoming unintentionally detached from the clip connection, the optical element 22 has fasteners 30 which have been designed to mask edge portions 32 of the absorber element 24 and to fix the absorber element 24 to the base support 18.

As is evident, in particular, in FIGS. 2 to 4, the fasteners 30 are arranged on two opposing sides of the optical element 22, the fasteners 30 taking the form of tabs 34 which mask the edge portions 32 of the absorber element 24.

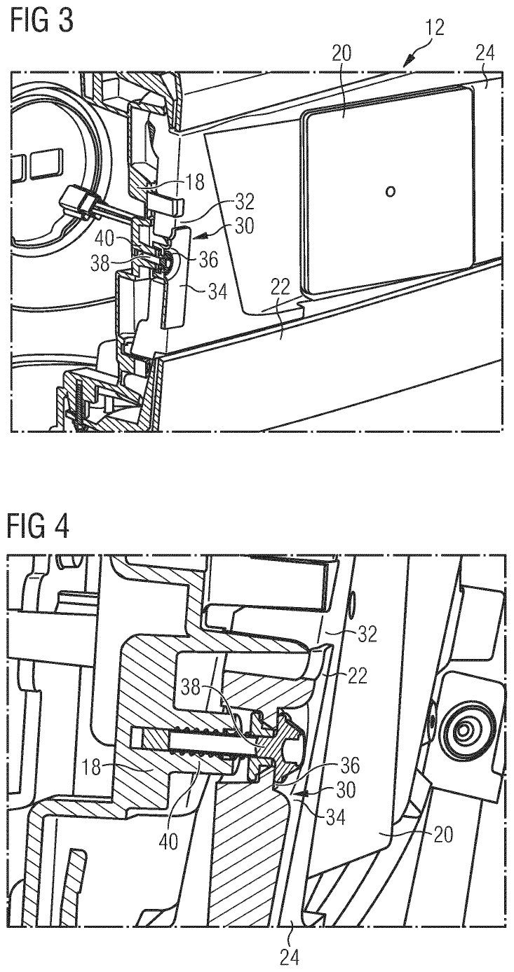

Apertures 36 have been introduced into the tabs, through each of which apertures a screw 38 has been passed and has been screwed into a threaded aperture 40 of the base support 18, as can be discerned, in particular, in FIGS. 3 and 4. Since the tabs 34 mask the edge portions 32 of the absorber element 24, the absorber element 24 is pressed in and fixed to the base support 18 when the screws 38 are being screwed into the threaded aperture 40.

The radar system 10 is distinguished by the use of the optical element 22, which is used anyway for optical reasons, for the purpose of masking, or encompassing, the absorber element 24, in order to fix the absorber element 24 to the base support 18 in a sandwich form of construction. By virtue of this, an unclipping of the absorber element 24 from the base support 18 is prevented. The radar system 10 consequently prevents, in simple and cost-effective manner, a detachment of the absorber element 24 from the base support 18.

### LIST OF REFERENCE SYMBOLS

10 vehicle
12 radar system
14 front end of vehicle
16 kidney grille
18 base support
20 radar
22 optical element
24 absorber element
26 clip
28 recess
30 fastener
32 edge portion
34 tab
36 aperture
38 screw
40 threaded aperture

1.-10. (canceled)

11. A radar system for a vehicle, the radar system comprising:
a base support for fastening to the vehicle,
a radar which is connected to the base support,
an optical element which is connected to the base support and which is spaced from the radar, and
an absorber element which is arranged between the radar and the optical element,
wherein the optical element has at least two fasteners which are configured to mask portions of the absorber element and to fix the absorber element to the base support.

12. The radar system according to claim 11, wherein the fasteners fix the portions to the base support by positive closure and/or by force closure.

13. The radar system according to claim 11, wherein the fasteners mask edge portions of the absorber element.

14. The radar system according to claim 11, wherein the fasteners have been screwed to the base support.

15. The radar system according to claim 11, wherein the fasteners are arranged on two opposing sides of the optical element.

16. The radar system according to claim 11, wherein one of the fasteners takes a form of a tab which masks the portion of the absorber element.

17. The radar system according to claim 11, wherein the base support has a detent element which is interlocked with a recess introduced into in the absorber element.

18. The radar system according to claim 11, wherein the optical element is a light-conducting element and/or a diaphragm.

19. The radar system according to claim 11, wherein the absorber element is produced from an expanded polypropylene.

20. The vehicle comprising the radar system according to claim 11.
